(19) United States
(12) Patent Application Publication
(10) Pub. No.: US 2016/0247135 A1
(43) Pub. Date: Aug. 25, 2016

(54) AGE-VERIFICATION DATA MONITORING AND ALERTING

(71) Applicant: NCR Corporation, Duluth, GA (US)

(72) Inventors: Joel Aaron Miller, Atlanta, GA (US); John DeSetto, Cumming, GA (US); Steven Jarrett Giera, Dacula, GA (US)

(21) Appl. No.: 14/627,480

(22) Filed: Feb. 20, 2015

(51) Int. Cl. G06Q 20/20; G06F 17/30

(52) U.S. Cl. CPC G06Q 20/202; G06F 17/30864; G06Q 50/265

(57) ABSTRACT

Various embodiments herein each include at least one of systems, methods, software, and data flows for age-verification data monitoring and alerting. Such embodiments generally operate to monitor compliance of sales of age-restricted controlled-products in retail environments and providing alerts when potential compliance issues are identified, which may made in near real-time as new transaction data is received. One method embodiment includes storing data representative of age-verification input received with regard to each of a plurality of purchase transactions and processing the data representative of age-verification input in view of at least one compliance rule to identify a potential compliance issue. When a potential compliance issue is identified, such embodiments include generating and providing a potential compliance issue alert.

### BACKGROUND INFORMATION

Many retailers sell controlled-products that are age-restricted for purchase. Such products may include alcohol, tobacco, lottery tickets, firearms and ammunition, medicines, and the like. Sale of these products often requires retailers to obtain and maintain a license or permit. When a retailer sells an age-restricted controlled-product to an underage customer, the retailer can be subject to penalties that may include license suspension or revocation and fines.

To help ensure compliance when selling age-restricted controlled-products, retailers have implemented data input requirements on Point-Of-Sale terminals, such as cash registers, that require clerks to input certain data. This data may include one or more of a customer date of birth, a scan or swipe of a driver's license, a driver's license number, selection of a POS terminal button indicating the customer appears to be over a certain age such as 30 or 40 years, and the like. While such efforts have provided a compliance mechanism, these efforts are not fail-safe and still include a human-element that can be bypassed.

### SUMMARY

Various embodiments herein each include at least one of systems, methods, software, and data flows for age-verification data monitoring and alerting. Such embodiments generally operate to monitor compliance of sales of age-restricted controlled-products in retail environments and providing alerts when potential compliance issues are identified.

One method embodiment includes storing data representative of age-verification input received with regard to each of a plurality of purchase transactions and processing the data representative of age-verification input in view of at least one compliance rule to identify a potential compliance issue. When a potential compliance issue is identified, such embodiments include generating and providing a potential compliance issue alert.

Another method embodiment includes processing data representative of age-verification input received within Point-Of-Sale (POS) terminal transactions in view of at least one compliance rule to identify potential compliance issues. When a potential compliance issue is identified, the method of this embodiment includes generating and providing a potential compliance issue alert to at least one recipient account.

One system embodiment includes a computing system with at least one processor, at least one network interface device, and at least one memory device. The at least one memory devices stores instructions that, when executed on the at least one processor, cause the processor to perform data processing activities. The data processing activities include receiving, via the at least one network interface device, and storing, on the at least one memory device, data representative of age-verification input received with regard to each of a plurality of purchase transactions. The data processing activities further include processing the data representative of age-verification input in view of at least one compliance rule to identify a potential compliance issue and when a potential compliance issue is identified, generating and providing a potential compliance issue alert

### BRIEF DESCRIPTION OF THE DRAWINGS

FIG. 1 is a logical block diagram of a system architecture, according to an example embodiment.

FIG. 2 is a block flow diagram of a method, according to an example embodiment.

FIG. 3 is a block diagram of a computing device, according to an example embodiment.

### DETAILED DESCRIPTION

Various embodiments herein each include at least one of systems, methods, software, and data flows for age-verification data monitoring and alerting. Such embodiments generally operate to monitor compliance of sales of age-restricted controlled-products in retail environments and providing alerts when potential compliance issues are identified. Various embodiments may be implemented at one or more system levels within a retail environment. For example, an analytics process that operates to identify potential compliance issues in representations of received age-verification input data of completed sales transactions of age-restricted controlled products. The analytics process operates to identify one or both of trends and anomalies in the age-verification input data. The analytics process may execute on one or more of a POS terminal, a server deployed at a store that receives and stores transaction data of transactions completed on POS terminals within the store, a regional or company-wide server that receives transaction data from all company stores, and a server that receives transaction data from and provides analytics services to many entities.

Regardless of where the analytics process is deployed, the analytics process, as mentioned above, operates to identify potential compliance issues in representations of received age-verification input data of completed sales transactions of age-restricted controlled products. Such trends and anomalies may include one or more of a frequency of birthdates input for age verification being of identical numbers (i.e., 11/11/11, 8/8/88, etc.), a frequency of the same birthdate received for many transactions, a frequency of an over a certain age input, different dates of birth received as input between different transactions associated with a single customer account (i.e., credit card, store loyalty account, etc.), a frequency of the same driver's license being used and the like. The frequencies may be measured against one or more of configured threshold frequencies and determined or received statics defining normal occurrences of received age verification input types and patterns.

Potential age-verification compliance issues may be monitored with regard to one or more of individual POS terminal clerks (i.e., cashiers), individual and groups of POS terminals such as store or store department, and amongst all stores of a region or an entire company. When a potential age-verification compliance issue is identified, an alert is typically provided to one or more people or defined roles to which certain individuals may be assigned, such as a manager or a person associated with a manager role. The alert may be provided in one or more different ways in various embodiments. For example, an alert may be provided within an app or application that may execute on a personal computer, a mobile device, or in a manner that provides a web browser view. The alert may also or alternatively be provided via a text message to a mobile device, a phone call to a phone number, and other similar messaging modes. The alert may identify one or more subjects of the alert, such as a particular clerk, POS terminal, department, or store and include an indication of the trend or anomaly type identified.

In some embodiments when a potential age-verification compliance issue is identified, a command may be issued from the analytics process to modify POS terminal behavior when receiving age verification input in future transactions. For example, the POS terminal behavior may be modified to require supervisor level intervention when receiving age verification input, not accepting certain types of age verification input such as an input birthdate and instead require a scan of a driver's license, and the like.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

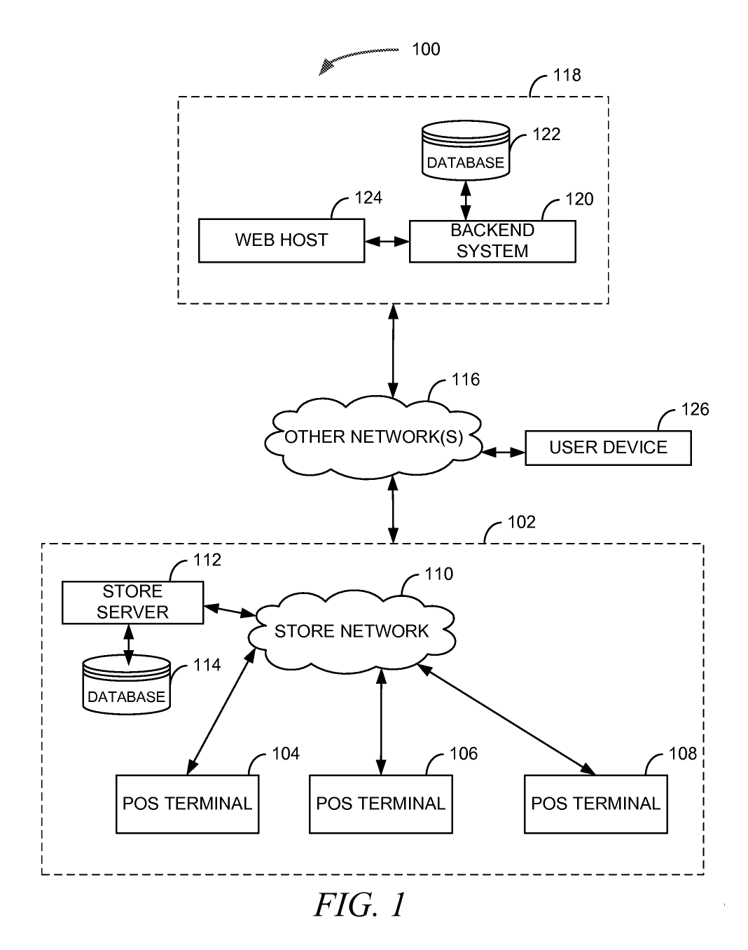

FIG. 1 is a logical block diagram of a system 100 architecture, according to an example embodiment. The system 100 is an example of a computing environment within which various embodiments may be implemented. The system 100 architecture is provided as only one example architecture on which some embodiments may be implemented. Other architectures may be utilized in other embodiments.

The system 100 includes a store 102 and a remote data processing center 118. The remote data processing center, in some embodiments, may be a corporate or regional data processing center of an entity that operates the store 102. In other embodiments, the data processing center 118 may be operated by an entity providing data analytics services, such as age verification compliance monitoring and alerting services with regard to data received from stores 102 over one or more other networks 116. Thus, although only a single store 102 is illustrated, in various embodiments there may be many stores 102.

The store 102, as illustrated, includes three POS terminals (104, 106, 108 connected to a store network 110. The store 102 also includes a store server 112 that may include a database 114 thereon or as may otherwise be accessible via the store network 110. Although three POS terminals 104, 106, 108 are illustrated, the store 102 may include fewer or greater numbers of POS terminals. The POS terminals 104, 106, 108 may include one or a combination of various terminal types. For example, the POS terminals 104, 106, 108 may include standard cashier operated POS terminals, self-checkout terminals where a clerk attending to one or more of such terminals may be called to provide age verification input, a mobile device terminal (e.g., a POS app that executes on a mobile telephone, computer, or tablet), and the like. Generally speaking, the POS terminals 104, 106, 108 are a form of computing device that executes software to process purchase transactions, receive age verification input with regard thereto, and to locally store or provide data with regard to processed purchase transactions to at least one computing system, such as a store server 112 and a backend system 120, such that age-verification data monitoring and alerting can be performed with regard to the transaction data.

The store 102 may also include a store server 112 in some embodiments. The store server 112 may receive transaction data from the POS terminals 104, 106, 108 including a representation of received age-verification input. The store server 112 may then store the received data to a database 114 or the POS terminals 104, 106, 108 may instead store such data directly to the database 114 via the store network 110. Regardless of how the data reaches the database 114, an analytics process executes against the transaction data including the data representative of received age-verification input to monitor the age verification input for potential compliance issues and to generate and provide an alert when a potential compliance issue is detected.

However, not all embodiments will include a store server 112 and database 114 within the store 102. In other embodiments where the store 102 does not include a store server 112 and database 114, the transaction data may instead be provided by the POS terminals 104, 106, 108 do a backend system 120 and database 122 located in a data processing center 118 accessible via one or more of the store network 110 and one or more other networks 116. The one or more other networks 116 may include one or more of a virtual private network, a wide area network, the Internet, a network operated by a wireless service provider, dedicated and leased networks, and the like. Regardless of the network and network types over which the data may be provided to the backend system 120 and database 122, the data may be provided from the POS terminals 104, 106, 108 in either a push or pull types of arrangements. Similar to the store server 112, the backend system 120 includes an analytics process that executes thereon against the transaction data including the data representative of received age-verification input to monitor the age verification input for potential compliance issues and to generate and provide an alert when a potential compliance issue is detected. Note that in some embodiments, an analytics process may execute on more than one of the store server 112, the backend system 120, and one or more of the POS terminals 104, 106, 108.

Regardless of which of the store server 112, the backend system 120, and one or more of the POS terminals 104, 106, 108 on which an analytics process executes to identify potential compliance issues in the received age-verification input, the analytics process executes to retrieve various items transaction data including representations of received age-verification input to identify trends and anomalies therein with regard to one or more of a POS terminal, a POS terminal user, a store, a group of stores, and a company as a whole that operates a group of stores. Such trends and anomalies may include one or more of a frequency of birthdates input for age verification being of identical numbers (i.e., 11/11/11, 8/8/88, etc.), a frequency of the same birthdate received for many transactions, a frequency of an over a certain age input, different dates of birth received as input between different transactions associated with a single customer account (i.e., credit card, store loyalty account, etc.), a frequency of the same driver's license being used and the like. The frequencies may be measured against one or more of configured threshold frequencies and determined or received statics defining normal occurrences of received age verification input types and patterns. Various algorithms may be defined and configured in different embodiments based on operator requirements, experience, legal requirements, and types of input that may be received. These algorithms may be considered compliance rules.

When a potential age-verification compliance issue is detected, an alert is generated. The purpose of such an alert may be to notify one or more people of the potential compliance issue so they know to investigate to ensure necessary legal and policy compliance standards are maintained. An alert may be communicated to each of the one or more people via an email, a text message, data presented in a user interface of a computer or mobile device application or app, such as may be present or accessible on a user device 126. For example, the user device 126 may be a mobile telephone that includes an app thereon that presents analytical data views of data including data views generated from age-verification compliance analytics and alert messages and data views generated upon identification of a potential age-verification compliance issue. The analytics process upon identification of a potential compliance issue may then generate a provide an alert message to the user device 126 of a responsible manager via one or more of the other networks 116 in the form of one or both of an email and text message that may be received and presented by the user device 126. The alert may also or alternatively be provided in a mobile device app user interface, such as a dashboard view, accessible by the user device 126 from the backend system and database via a web host 124.

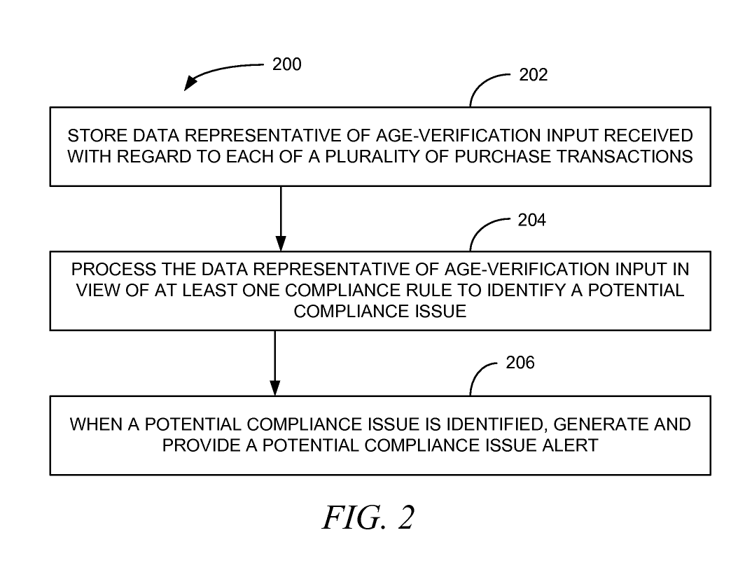

FIG. 2 is a block flow diagram of a method 200, according to an example embodiment. The method 200 is an example of a method implemented to perform age-verification data monitoring and alerting with regard to transactions for purchase of age-restricted controlled goods. In various embodiments, the method 200 may be performed POS terminal, a store server, a backend system, as a cloud-provided service, and the like.

The method 200 includes storing 202 data representative of age-verification input received with regard to each of a plurality of purchase transactions. The data generally originates on a POS terminal as input during the processing of a purchase transaction and may be stored locally to the POS terminal, transmitted to a server for processing and storage in a database, stored to a database, or a combination thereof. The method 200 further includes processing 204 the data representative of age-verification input in view of at least one compliance rule to identify a potential compliance issue. Then, when a potential compliance issue is identified, the method 200 generates 206 and provides a potential compliance issue alert, such as by email, text message, or via an app or application. The alert is provided to a person, a role having one or more people assigned thereto, having supervisory authority over one or more of the store, clerk, and equipment such as the POS terminal, involved in processing the transaction. In some embodiments, the alert may be or also include a command that is sent to one or more POS terminals involved in or related to the identified potential compliance issue. The command may be processed by the recipient POS terminal(s) to modify the behavior thereof, such as to require supervisor input to confirm age-verification input, to disallow certain types of age verification input, or otherwise to increase scrutiny during age verification.

In some embodiments of the method 200, the at least one compliance rule includes a process that executes with regard to the stored data representative of age-verification input to identify patterns of age-verification input received over a period. Patterns of age-verification input received over a period may include one or more of:
a frequency of identical customer birthdate age-verification input received above a birthdate threshold;
a frequency of an adequate-age input above an adequate-age threshold;
a number of occurrences where no age-verification input is received;
a frequency where a customer identification card has not been scanned; and
a derivation of age-verification input from a data model derived from historical stored age-verification input, among others.

The method of claim 3, wherein the period considered to identify patterns and anomalies in received age verification input may include one or a plurality of periods. For example, such periods may include a period measured in at least one of minutes and hours, a period measured by at least one day, a number of transactions, all transactions, and a period defined by at least one configuration setting of a system that performs the method. Other periods may also or alternatively be defined in various embodiments. Further, one or more compliance rules may be applied for each of a plurality of periods.

In some embodiments, generating 206 and providing the potential compliance issue alert includes generating an electronic message including information with regard to the identified potential compliance issue and sending the electronic message to a recipient identified from configuration data of a system performing the method 200. In further embodiments, generating 206 and providing the potential compliance issue alert may also or alternatively include adding data representative of the identified potential compliance issue to a dataset from which an activity data view is generated within a user interface of a user configured as having supervisory data viewing permission. Such a user interface may be a user interface viewable within a mobile device app, in a thick client application as may execute on a personal computer or other computing device, or may be accessed via a web browser.

In some embodiments, the stored 202 data representative of age-verification input received with regard to each of the plurality of purchase transactions includes data associating the stored data with at least one of a Point-Of-Sale (POS) terminal and a POS terminal user. In such embodiments, a potential compliance issue alert is generated with regard to at least one of a POS terminal and a POS terminal user for which the potential compliance issue was identified. In some such embodiments, the processing 204 of the data representative of age-verification input in view of at least one compliance rule to identify the potential compliance issue is performed with regard to at least one of transactions conducted on each of a plurality of POS terminals, each POS terminal user, and transactions conducted on all POS terminals associated with a defined location.

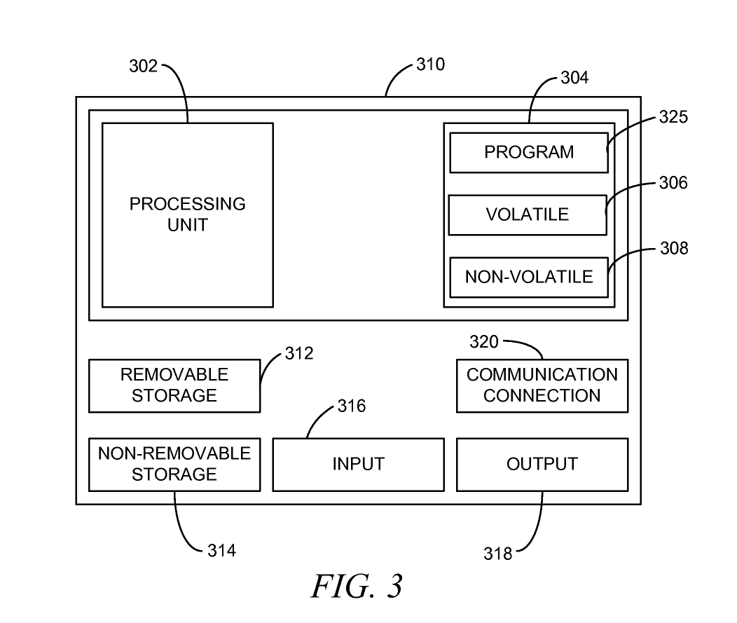

FIG. 3 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 310, may include a processing unit 302, memory 304, removable storage 312, and non-removable storage 314. Although the example computing device is illustrated and described as computer 310, the computing device may be in different forms in different embodiments. For example, the computing device may instead be a smartphone, a tablet, smartwatch, or other computing device including the same or similar elements as illustrated and described with regard to FIG. 3. Devices such as smartphones, tablets, and smartwatches are generally collectively referred to as mobile devices. Further, although the various data storage elements are illustrated as part of the computer 310, the storage may also or alternatively include cloud-based storage accessible via a network, such as the Internet.

Returning to the computer 310, memory 304 may include volatile memory 306 and non-volatile memory 308. Computer 310 may include—or have access to a computing environment that includes a variety of computer-readable media, such as volatile memory 306 and non-volatile memory 308, removable storage 312 and non-removable storage 314. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 310 may include or have access to a computing environment that includes input 316, output 318, and a communication connection 320. The input 316 may include one or more of a touchscreen, touchpad, mouse, keyboard, camera, one or more device-specific buttons, one or more sensors integrated within or coupled via wired or wireless data connections to the computer 310, and other input devices. The computer 310 may operate in a networked environment using a communication connection 320 to connect to one or more remote computers, such as database servers, web servers, and other computing device. An example remote computer may include a personal computer (PC), server, router, network PC, a peer device or other common network node, or the like. The communication connection 320 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 320 may also or alternatively include a transceiver device, such as a BLUETOOTH® device that enables the computer 310 to wirelessly receive data from and transmit data to other BLUETOOTH® devices.

Computer-readable instructions stored on a computer-readable medium are executable by the processing unit 302 of the computer 310. A hard drive (magnetic disk or solid state), CD-ROM, and RAM are some examples of articles including a non-transitory computer-readable medium. For example, various computer programs 325 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
storing data representative of age-verification input received with regard to each of a plurality of purchase transactions;
processing the data representative of age-verification input in view of at least one compliance rule to identify a potential compliance issue; and
when a potential compliance issue is identified, generating and providing a potential compliance issue alert.

2. The method of claim 1, wherein the at least one compliance rule includes a process that executes with regard to the stored data representative of age-verification input to identify patterns of age-verification input received over a period.

3. The method of claim 2, wherein the patterns of age-verification input received over a period include at least one of:
a frequency of identical customer birthdate age-verification input received above a birthdate threshold;
a frequency of an adequate-age input above an adequate-age threshold;
a number of occurrences where no age-verification input is received;
a frequency where a customer identification card has not been scanned; and
a derivation of age-verification input from a data model derived from historical stored age-verification input.

4. The method of claim 3, wherein the period includes a plurality of periods for at least one of the patterns, each period of which the processing considers for pattern identification, each of the plurality of periods being one of:
a time period measured in at least one of minutes and hours;
a time period measured by at least one day;
a number of transactions;
all transactions; and
a period defined by at least one configuration setting of a system that performs the method.

5. The method of claim 1, wherein generating and providing the potential compliance issue alert includes at least one of:
generating an electronic message including information with regard to the identified potential compliance issue and sending the electronic message to a recipient identified from configuration data of a system performing the method; and
adding data representative of the identified potential compliance issue to a dataset from which an activity data view is generated within a user interface of a user configured as having supervisory data viewing permission.

6. The method of claim 1, wherein:
the stored data representative of age-verification input received with regard to each of the plurality of purchase transactions includes data associating the stored data with at least one of a Point-Of-Sale (POS) terminal and a POS terminal user; and
a potential compliance issue alert is generated with regard to at least one of a POS terminal and a POS terminal user for which the potential compliance issue was identified.

7. The method of claim 6, wherein the processing of the data representative of age-verification input in view of at least one compliance rule to identify the potential compliance issue is performed with regard to at least one of:
transactions conducted on each of a plurality of POS terminals;
each POS terminal user; and
transactions conducted on all POS terminals associated with a defined location.

8. The method of claim 7, further comprising:
upon identification of the potential compliance issue, sending a command, via a network, to a at least one POS terminal associated with either the purchase transactions or a POS terminal user involved in the purchase transactions for which the potential compliance issue was identified, the command instructing the at least one POS terminal to modify its behavior when age-verification input is to be collected with regard to a purchase transaction.

9. The method of claim 8, wherein the command instructing the at least one POS terminal to modify its behavior when age-verification input is to be collected with regard to a purchase transaction, when processed by a receiving POS terminal, causes the POS terminal to obtain a higher authority level approval before completing the transaction.

10. A method comprising:
processing data representative of age-verification input received within Point-Of-Sale (POS) terminal transactions in view of at least one compliance rule to identify potential compliance issues; and
when a potential compliance issue is identified, generating and providing a potential compliance issue alert to at least one recipient account.

11. The method of claim 10, wherein the at least one compliance rule includes a process that executes with regard to the stored data representative of age-verification input to identify patterns of age-verification input received over a period, the patterns including at least one of:
a frequency of identical customer birthdate age-verification input received above a birthdate threshold;
a frequency of an adequate-age input above an adequate-age threshold;
a number of occurrences where no age-verification input is received;
a frequency where a customer identification card has not been scanned; and
a derivation of age-verification input from a data model derived from historical stored age-verification input.

12. The method of claim 11, wherein the period includes a plurality of periods for at least one of the patterns, each period of which the processing considers for pattern identification, each of the plurality of periods being one of:
a period measured in at least one of minutes and hours;
a period measured by at least one day;
a number of transactions;
all transactions; and
a period defined by at least one configuration setting of a system that performs the method.

13. The method of claim 10, wherein generating and providing the potential compliance issue alert to at least one recipient account includes at least one of:
generating an email including information with regard to the identified potential compliance issue and sending the email to a recipient identified from configuration data of a system performing the method; and
adding data representative of the identified potential compliance issue to a dataset from which an activity data view is generated within a user interface when viewed by a user.

14. The method of claim 10, wherein:
the data representative of age-verification input received within POS terminal transactions includes data associating the each POS transaction with at least one of a Point-Of-Sale (POS) terminal and a POS terminal user; and
a potential compliance issue alert is generated with regard to at least one of a POS terminal and a POS terminal user for which the potential compliance issue was identified;
wherein the processing of the data representative of age-verification input in view of at least one compliance rule to identify the potential compliance issue is performed with regard to at least one of:
transactions conducted on each of a plurality of POS terminals;
each POS terminal user; and
transactions conducted on all POS terminals associated with a defined location.

15. The method of claim 14, further comprising:
upon identification of the potential compliance issue, sending a command, via a network, to a at least one POS terminal associated with either the purchase transactions or a POS terminal user involved in the purchase transactions for which the potential compliance issue was identified, the command instructing the at least one POS terminal to modify its behavior when age-verification input is to be collected with regard to a purchase transaction.

16. A system comprising:
at least one processor;
at least one network interface device; and
at least one memory device, including instructions that, when executed on the at least one processor, cause the processor to perform data processing activities comprising:
receiving, via the at least one network interface device, and storing, on the at least one memory device, data representative of age-verification input received with regard to each of a plurality of purchase transactions;
processing the data representative of age-verification input in view of at least one compliance rule to identify a potential compliance issue; and
when a potential compliance issue is identified, generating and providing a potential compliance issue alert.

17. The system of claim 16, wherein the at least one compliance rule includes a at least one process that executes with regard to the stored data representative of age-verification input to identify patterns of age-verification input received over a period, wherein the patterns of age-verification input received over a period include at least one of:
a frequency of identical customer birthdate age-verification input received above a birthdate threshold;
a frequency of an adequate-age input above an adequate-age threshold;
a number of occurrences where no age-verification input is received;
a frequency where a customer identification card has not been scanned; and
a derivation of age-verification input from a data model derived from historical stored age-verification input.

18. The system of claim 17, wherein the period includes a plurality of periods for at least one of the patterns, each period of which the processing considers for pattern identification, each of the plurality of periods being one of:
a period measured in at least one of minutes and hours;
a period measured by at least one day;
a number of transactions;
all transactions; and
a period defined by at least one configuration setting of a system that performs the method.

19. The system of claim 16, wherein generating and providing the potential compliance issue alert includes at least one of:
generating an electronic message including information with regard to the identified potential compliance issue and sending the electronic message via the at least one network interface device to a recipient identified from configuration data stored on the at least one memory device; and
storing data representative of the identified potential compliance issue to a dataset from which an activity data view is generated within a user interface of a user configured as having supervisory data viewing permission.

20. The system of claim 16, wherein:
the stored data representative of age-verification input includes data associating the stored data with at least one of a Point-Of-Sale (POS) terminal and a POS terminal user; and
a potential compliance issue alert is generated with regard to at least one of a POS terminal and a POS terminal user for which the potential compliance issue was identified;
the processing of the data representative of age-verification input in view of at least one compliance rule to identify the potential compliance issue is performed with regard to at least one of transactions conducted on each of a plurality of POS terminals, each POS terminal user, and transactions conducted on all POS terminals associated with a defined location;
the data processing activities further comprise:
upon identification of the potential compliance issue, sending a command, via the at least one network interface device, to a at least one POS terminal associated with either the purchase transactions or a POS terminal user involved in the purchase transactions for which the potential compliance issue was identified, the command instructing the at least one POS terminal to cause the POS terminal to obtain a higher authority level approval before completing the transaction.
